(19) United States
(12) Patent Application Publication
(10) Pub. No.: US 2024/0418531 A1
(43) Pub. Date: Dec. 19, 2024

(54) MAP GENERATION APPARATUS

(71) Applicant: Honda Motor Co., Ltd., Tokyo (JP)

(72) Inventor: Yuki Okuma, Tokyo (JP)

(21) Appl. No.: 18/743,413

(22) Filed: Jun. 14, 2024

(30) Foreign Application Priority Data
Jun. 19, 2023 (JP) 2023-100138

(51) Int. Cl. G01C 21/00; B60W 60/00

(52) U.S. Cl. CPC G01C 21/3815; B60W 60/001; G01C 21/3833; G01C 21/387; B60W 2556/20; B60W 2556/35; B60W 2556/40

(57) ABSTRACT

A map generation apparatus includes an in-vehicle detector and a microprocessor. The microprocessor is configured to perform: recognizing an exterior environment situation around a subject vehicle by using a detection data of the in-vehicle detector, generating a map including position information of a predetermined feature based on recognition information acquired in the recognizing; calculating a reliability of the generated map, for each piece of position information; storing the map and reliability information indicating the reliability as map information; and updating, when at least a part of a new map newly generated in the generating is included in the existing map, data of a corresponding section of the existing map corresponding to a generation section of the new map based on data and the reliability of the new map in the generation section and data and the reliability of the existing map in the corresponding section.

### CROSS-REFERENCE TO RELATED APPLICATION

This application is based upon and claims the benefit of priority from Japanese Patent Application No. 2023-100138 filed on Jun. 19, 2023, the content of which is incorporated herein by reference.

### BACKGROUND

### Technical Field

The present invention relates to a map generation apparatus configured to generate a map on the basis of the information acquired by a vehicle.

### Related Art

As this type of technique, a map generation apparatus that collects the information acquired by an in-vehicle sensor mounted on a vehicle and generates a map on the basis of the collected information is known (see WO 2021/002190 A1). In such a map generation apparatus, when an existing map that has already been created is updated using newly collected information, it is desirable not only to suppress a decrease in the accuracy of map data but also to improve the map data by updating.

In the conventional technique, difference data is obtained by comparing integrated probe map data obtained by integrating newly collected probe data with existing basic map data, and the existing basic map data is updated on the basis of average difference data obtained by averaging a plurality of pieces of difference data. Therefore, if there is difference data including many errors that have not been excluded as the transient difference data, under the great influence of the difference data, the accuracy of the existing basic map data is decreased.

Suppression of a decrease in the accuracy of the map data enables smooth movement of the vehicle, leading to improvement in the convenience and safety of traffic. As a result, it is possible to contribute to development of a sustainable transportation system.

### SUMMARY

An aspect of the present invention is a map generation apparatus including: an in-vehicle detector configured to detect an external situation around a subject vehicle; and a microprocessor and a memory coupled to the microprocessor. The microprocessor is configured to perform: recognizing an exterior environment situation around a subject vehicle by using a detection data of the in-vehicle detector; generating a map including position information indicating a position of a predetermined feature based on recognition information acquired in the recognizing; calculating a reliability of the map generated in the generating, for each piece of position information; storing the map and reliability information indicating the reliability as map information; and updating, when at least a part of a new map newly generated in the generating is included in the existing map stored in the memory unit as the map information, data of a corresponding section of the existing map corresponding to a generation section of the new map based on data and the reliability of the new map in the generation section and data and the reliability of the existing map in the corresponding section.

### BRIEF DESCRIPTION OF DRAWINGS

The objects, features, and advantages of the present invention will become clearer from the following description of embodiments in relation to the attached drawings, in which:

FIG. 1 is a block diagram illustrating a schematic configuration of a vehicle control system including a map generation apparatus according to the embodiment of the invention;

FIG. 2 is a block diagram illustrating a main configuration of the map generation apparatus according to the embodiment;

FIG. 3A is a schematic diagram for explaining the distribution of the estimated values of the position of a feature on a map;

FIG. 3B is a schematic diagram illustrating a relationship among an existing map, a new map, and an updated map;

FIG. 4A is a diagram illustrating a scene where a subject vehicle travels on a road;

FIG. 4B is a schematic diagram illustrating point cloud data on a two-dimensional map;

FIG. 5 is a flowchart illustrating an example of processing performed by the controller in FIG. 2;

FIG. 6A is a schematic diagram illustrating fusion processing; and

FIG. 6B is another schematic diagram illustrating fusion processing.

### DETAILED DESCRIPTION

An embodiment of the invention will be described below with reference to the drawings.

A map generation apparatus according to the embodiment is configured to generate, for example, a map (environmental map to be described later) used when a vehicle (self-driving vehicle) having a self-driving capability travels. Hereinafter, the vehicle on which the map generation apparatus according to the embodiment is mounted may be referred to as subject vehicle to be distinguished from other vehicles.

The map generation apparatus generates a map when a driver manually drives the subject vehicle. Therefore, the map generation apparatus can also be provided in a vehicle (manual driving vehicle) not having a self-driving capability.

The map generation apparatus generates an environmental map including three-dimensional point cloud data using detection values detected by an external sensor group to be described later while the subject vehicle is traveling. For example, edges indicating an outline of an object as a feature are extracted from camera images acquired by a camera included in the external sensor group on the basis of luminance and color information for each pixel, and a feature point is extracted using the edge information. The feature point is, for example, a point on the edges or an intersection point of the edges, and corresponds to a division line on a road surface, a corner of a building, a corner of a road sign, or the like. The map generation apparatus obtains a distance from a subject vehicle to the above feature point with a light detection and ranging (LiDAR) or a radar included in the external sensor group, records the feature point on an environmental map, and generates an environmental map around the road on which the subject vehicle has traveled.

Note that, the map generation apparatus can be provided not only in a manual driving vehicle but also in a self-driving vehicle capable of switching from a self-drive mode that does not require a driving operation by a driver to a manual drive mode that requires a driving operation by a driver. Hereinafter, the map generation apparatus will be described assuming that the map generation apparatus is provided in the self-driving vehicle.

### <Self-Driving Vehicle>

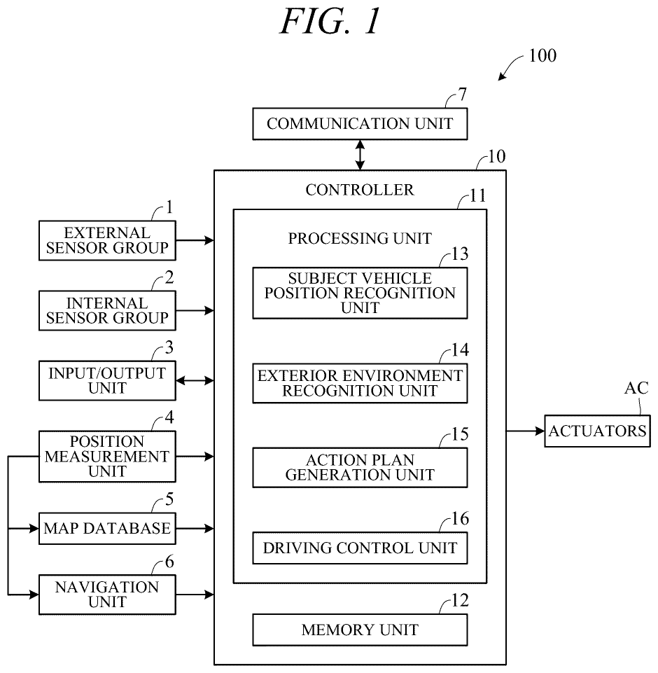

First, the configuration of a self-driving vehicle will be described. A subject vehicle may be any of an engine vehicle including an internal combustion engine (engine) as a traveling drive source, an electric vehicle including a traveling motor as a traveling drive source, and a hybrid vehicle including an engine and a traveling motor as traveling drive sources. FIG. 1 is a block diagram illustrating a schematic configuration of a vehicle control system 100 including a map generation apparatus according to the embodiment.

As illustrated in FIG. 1, the vehicle control system 100 mainly includes a controller 10, and an external sensor group 1, an internal sensor group 2, an input/output device 3, a position measurement unit 4, a map database 5, a navigation unit 6, a communication unit 7, and a traveling actuator AC, which are each communicably connected to the controller 10 via a controller area network (CAN) communication line or the like.

The external sensor group 1 is a generic term for a plurality of sensors (external sensors) that detect an external situation which is peripheral information of the subject vehicle. For example, the external sensor group 1 includes a camera that is mounted on the subject vehicle, has an imaging element (imaging sensor) such as a complementary metal oxide semiconductor (CMOS) sensor, and captures images of the surrounding (front, rear, and side) of the subject vehicle, and a LiDAR that irradiates the Laser light and detects reflected light to detect a position of objects around the subject vehicle, including a distance between the subject vehicle and the objects and a direction from the objects to the subject vehicle, and a radar that irradiates electromagnetic waves and detects reflected waves to detect objects around the subject vehicle.

The internal sensor group 2 is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects accelerations in a front-rear direction and a left-right direction of the subject vehicle, and a revolution sensor that detects the number of revolutions of the driving power source. The internal sensor group 2 further includes a sensor that detects driver's driving operation in a manual drive mode, for example, operation of an accelerator pedal, operation of a brake pedal, operation of a steering wheel, and the like.

The input/output device 3 is a generic term for devices via which the driver transmits or receives commands. For example, the input/output device 3 includes various switches to which the driver inputs various commands by operating an operation member, a microphone to which the driver inputs commands by voice, a display that provides information to the driver via a display image, and a speaker that provides information to the driver by voice, and the like.

The position measurement unit 4 has a positioning sensor for detecting signals for positioning transferred from a positioning satellite, and uses positioning information received by the positioning sensor to measure a current position (latitude, longitude, and altitude) of the subject vehicle. The positioning satellite is an artificial satellite such as a global positioning system (GPS) satellite or a quasi-zenith satellite. The positioning sensor may be included in the internal sensor group 2. The position measurement unit 4 may be referred as a global navigation satellite system (GNSS) unit.

The map database 5 is a device that stores general map information used for the navigation unit 6, and includes, for example, a hard disk or a semiconductor element. The map information includes road position information, information on a road shape (curvature or the like), and position information on intersections and branch points. The map information stored in the map database 5 is different from highly accurate map information of the environmental map stored in a memory unit 12 of the controller 10.

The navigation unit 6 is a device that searches for a target route on a road to a destination input by a driver and provides guidance along the target route. The input of the destination and the guidance along the target route are performed via the input/output device 3. The target route is calculated on the basis of a current position of the subject vehicle measured by the position measurement unit 4 and the map information stored in the map database 5. The current position of the subject vehicle can be measured using the detection values of the external sensor group 1, and the target route may be calculated on the basis of the current position and the environmental map information stored in the memory unit 12.

The communication unit 7 communicates with various servers (not illustrated) via networks including a wireless communication network represented by the Internet network, a mobile phone network, and the like, and acquires map information, travel history information, traffic information, and the like from the servers periodically or at a certain timing. The networks include not only a public wireless communication network but also a closed communication network provided for every predetermined management area, for example, a wireless LAN, Wi-Fi (registered trademark), Bluetooth (registered trademark), and the like. In a case where the acquired map information is the above general map information, a map of the map database 5 is updated. In a case where the acquired map information is the environmental map information, the environmental map stored in them memory unit 12 is updated. The communication unit 7 can communicate with other vehicles.

The actuators AC are traveling actuators for controlling traveling of the subject vehicle. In a case where the driving power source is an engine, the actuators AC include a throttle actuator that adjusts an opening (throttle opening) of a throttle valve of the engine. In a case where the driving power source is a driving motor, the driving motor is included in the actuators AC. The actuators AC also include a brake actuator that operates a braking device of the subject vehicle and a steering actuator that drives a steering device.

The controller 10 includes an electronic control unit (ECU). More specifically, the controller 10 includes a computer including a processing unit 11 such as a CPU (microprocessor), the memory unit 12 such as a ROM and a RAM, and other peripheral circuits (not illustrated) such as an I/O interface. Although a plurality of ECUs having different functions such as an engine control ECU, a driving motor control ECU, and a braking device ECU can be separately provided, in FIG. 1, the controller 10 is illustrated as a set of these ECUs for convenience.

The memory unit 12 stores highly accurate environmental map information. The environmental map information includes road position information, information of a road shape (curvature or the like), information of a road gradient, position information of an intersection or a branch point, information of the number of lanes (may be referred as traveling lanes), width of a lane and position information for each lane (information of a center position of a lane or a boundary line of a lane position), position information of a landmark (a traffic light, a sign, a building, or the like) as a mark on a map, information of a road surface profile such as unevenness of a road surface, and the like. The memory unit 12 stores the environmental map (data of the environmental map) and reliability information indicating a reliability of the environmental map, as the environmental map information. The memory unit 12 further can store travel history information indicating a driving path based on detection values of the external sensor group 1 and the internal sensor group 2.

The processing unit 11 includes a subject vehicle position recognition unit 13, an exterior environment recognition unit 14, an action plan generation unit 15, and a driving control unit 16 as functional configurations.

The subject vehicle position recognition unit 13 recognizes the position (subject vehicle position) of the subject vehicle on a map, on the basis of the position information of the subject vehicle, obtained by the position measurement unit 4, and the map information of the map database 5. The subject vehicle position may be recognized using the environmental map information stored in the memory unit 12 and the peripheral information of the subject vehicle detected by the external sensor group 1, and the subject vehicle position can be recognized with high accuracy. When the subject vehicle position may be measured by a sensor installed on a road or outside a road side, the subject vehicle position can be recognized by communicating with the sensor via the communication unit 7.

The subject vehicle position recognition unit 13 further perform subject vehicle position estimation processing in parallel with the map generation processing by the map generation unit 111, which is described below. The position estimation estimates the position of the subject vehicle based on a change in a position of features (feature points) over time. The map generation processing and the position estimation processing are performed simultaneously according to the SLAM (Simultaneous Localization and Mapping) algorithm using, for example, signals from the external sensor group 1 (camera and LiDAR), for example.

The exterior environment recognition unit 14 recognizes an external situation around the subject vehicle on the basis of signals from the external sensor group 1. For example, a position, a speed, and an acceleration of a surrounding vehicle (a forward vehicle or a rearward vehicle) traveling around the subject vehicle, a position of a surrounding vehicle stopped or parked around the subject vehicle, and positions and states of other objects are recognized. Other objects include a sign, a traffic light, indications such as division lines and stop lines on a road, a building, a guardrail, a utility pole, a signboard, a pedestrian, a bicycle, and the like. The states of other objects include a color (red, green, or yellow) of a traffic light, a moving speed and a direction of a pedestrian or a bicycle, and the like. The division lines include white lines (as well as lines of a different color, such as a yellow), curb lines, road studs and the like, and may be referred as lane marks.

The action plan generation unit 15 generates a driving path (target path) of the subject vehicle from the current point of time to a predetermined time ahead on the basis of, for example, the target route calculated by the navigation unit 6, the map information stored in the map database 5 (or the environmental map information stored in the memory unit 12), the subject vehicle position recognized by the subject vehicle position recognition unit 13, and the external situation recognized by the exterior environment recognition unit 14. When there is a plurality of paths that are candidates for the target path on the target route, the action plan generation unit 15 selects, from among the plurality of paths, an optimal path that satisfies criteria such as compliance with laws and regulations and efficient and safe traveling, and sets the selected path as the target path. Then, the action plan generation unit 15 generates an action plan corresponding to the generated target path. The action plan generation unit 15 generates various action plans corresponding to overtaking to pass a preceding vehicle, changing a lane to change a traveling lane, following a preceding vehicle, lane keeping to maintain a lane without departing from a traveling lane, decelerating or accelerating, and the like. At the generation of the target path, the action plan generation unit 15 first determines a travel mode, and then generates the target path on the basis of the travel mode.

In the self-drive mode, the driving control unit 16 controls each of the actuators AC so that the subject vehicle travels along the target path generated by the action plan generation unit 15. More specifically, the driving control unit 16 calculates a requested driving force for obtaining a target acceleration per unit time calculated by the action plan generation unit 15 in consideration of a travel resistance determined by the road gradient or the like in the self-drive mode. Then, for example, the actuators AC are feedback controlled so that an actual acceleration detected by the internal sensor group 2 becomes the target acceleration. More specifically, the actuators AC are controlled so that the subject vehicle travels at a target vehicle speed and the target acceleration. When a drive mode is the manual drive mode, the driving control unit 16 controls each of the actuators AC in accordance with a travel command (steering operation or the like) from the driver acquired by the internal sensor group 2.

### <Map Generation Apparatus>

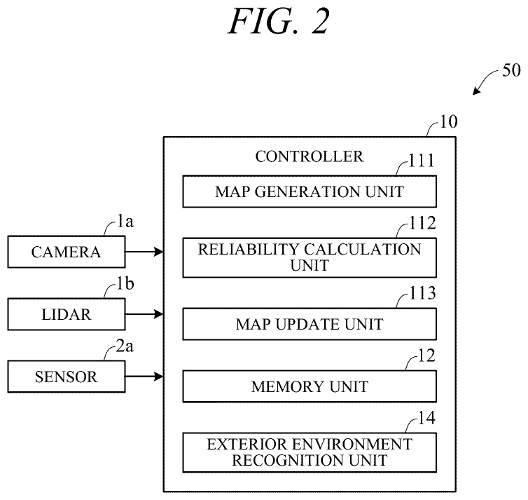

FIG. 2 is a block diagram illustrating a main configuration of a map generation apparatus 50 according to the embodiment. The map generation apparatus 50 is included in the vehicle control system 100 in FIG. 1. In FIG. 2, the map generation apparatus 50 includes a camera 1a, a LiDAR 1b, a sensor 2a, and the controller 10.

The camera 1a is a monocular camera having an image sensor such as a CMOS sensor, and is included in the external sensor group 1 in FIG. 1. The camera 1a may be a stereo camera. The camera 1a is attached at a predetermined position in front of a subject vehicle, and continuously captures an image of a space in front of the subject vehicle at a predetermined frame rate to acquire an image (camera image) of the peripheral vehicle described above and a target object as another object.

Note that, the target object may be detected by the LiDAR 1b or the like together with the camera 1a or instead of the camera 1a.

The LiDAR 1b is also included in the external sensor group 1. The LiDAR 1b is attached ahead of the subject vehicle such that a region to be observed during traveling is included in the field of view (hereinafter referred to as FOV) of the LiDAR 1b. The LiDAR 1b intermittently irradiates a plurality of detection points (may be referred to as irradiation points) in the FOV with laser beam to acquire, for each detection point, point information in which the irradiated laser beam is reflected (scattered) and returned at a certain point on the surface of the object. The point information includes the distance from a laser source (subject vehicle) to the point, the intensity of the laser beam reflected (scattered) and returned, and the relative velocity between the laser source and the point. In the embodiment, the data including the point information of a plurality of detection points in the FOV is referred to as point cloud data. The LiDAR 1b continuously acquires a predetermined number (the number of detection points in the FOV) of point cloud data per frame at a predetermined frame rate.

The sensor 2a is a detection unit used to calculate the movement amount and the movement direction of the subject vehicle. The sensor 2a is included in the internal sensor group 2, and includes, for example, a vehicle speed sensor and a yaw rate sensor. That is, the controller 10 (subject vehicle position recognition unit 13) calculates the movement amount of the subject vehicle by integrating the vehicle speed detected by the vehicle speed sensor, calculates a yaw angle by integrating the yaw rate detected by the yaw rate sensor, and estimates a position of the subject vehicle by odometry when a map is generated. Note that, the configuration of the sensor 2a is not limited thereto, and the controller 10 may estimate the position of the subject vehicle using information of another sensor.

The controller 10 in FIG. 2 includes a map generation unit 111, a reliability calculation unit 112, and a map update unit 113 in addition to a memory unit 12 and an exterior environment recognition unit 14 as a functional configuration undertaken by a processing unit 11 (FIG. 1).

The memory unit 12 stores environmental map information as described above. The environmental map stored in the memory unit 12 includes an environmental map (may be referred to as an external environmental map) acquired from the outside of the subject vehicle via the communication unit 7 and an environmental map (may be referred to as an internal environmental map) created by the map generation unit 111 using recognition information by the exterior environment recognition unit 14, detection values of the external sensor group 1 or detection values of the external sensor group 1 and the internal sensor group 2. The external environmental map is, for example, an environmental map acquired via a cloud server, and the internal environmental map is an environmental map created by mapping using a technique such as the SLAM. The external environmental map is shared by the subject vehicle and other vehicles, whereas the internal environmental map is a map independently included in the subject vehicle.

The memory unit 12 may also store information on various control programs, thresholds used in the programs, or the like.

The map generation unit 111 generates an environmental map including position information indicating a position of a feature such as a division line on a road surface while traveling in the manual drive mode. Specifically, the map generation unit 111 generates the internal environmental map including three-dimensional point cloud data. The map generation unit 111 extracts, for example, the feature points of the feature recognized by the exterior environment recognition unit 14 from the camera image acquired by the camera 1a. The map generation unit 111 further obtains the distance from the subject vehicle to the feature point using the distance measurement values based on the camera image or the detection values by the LiDAR 1b, and sequentially plots the feature points at a position separated by the distance obtained above from the position of the subject vehicle on the environmental map estimated by the subject vehicle position recognition unit 13, thereby generating the environmental map of the periphery of the road on which the subject vehicle has traveled.

Note that, as described above, the map generation unit 111 may perform map generation processing not only when traveling in the manual drive mode but also when traveling in the self-drive mode in the same way as in the manual drive mode.

The reliability calculation unit 112 calculates the reliability of the environmental map. For example, the position of the same feature (for example, a division line or the like) is measured a plurality of times, and the reliability of the environmental map is calculated on the basis of the distribution of the measurement positions obtained in the respective measurements. This reliability calculation method is based on a central limit theorem that “in a case where the population from which samples are extracted is an average μ and variance σ², the distribution of the sample averages approaches a normal distribution N (μ, σ²/n) of the average μ and the variance σ²/n as the number of samples n to be extracted increases”.

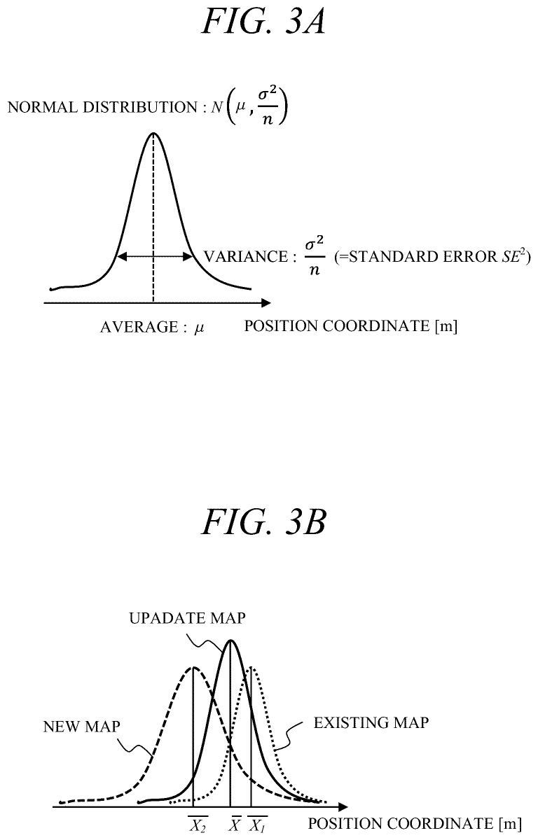

FIG. 3A is a schematic diagram for explaining the distribution of the estimated values of the position of a feature on a map. In the embodiment, among detection values of a plurality of frames acquired by the camera 1a at a predetermined frame rate, the position coordinates of the same feature acquired in the respective frames on the basis of detection values of n frames with close acquisition time correspond to n samples, and the average value (sample average) u of the n samples corresponds to the estimated position of the feature on the environmental map.

The reliability calculation unit 112 calculates the above variance σ²/n of the normal distribution N as reliability information indicating the reliability of the environmental map. It can be said that the smaller the variance σ²/n, the higher the reliability, and that the larger the variance σ²/n, the lower the reliability.

In a case where an environmental map different from the existing environmental map stored in the memory unit 12 is generated, the map update unit 113 updates the existing environmental map. Specifically, in a case where at least a part of a new environmental map newly generated by the map generation unit 111 is included in the existing environmental map stored in the memory unit 12, the map update unit 113 updates the data of the corresponding section of the existing environmental map corresponding to the generation section of the new map on the basis of the data and the reliability of the generation section of the new environmental map and the data and the reliability of the corresponding section of the existing environmental map. That is, when the updated environmental map is generated by fusing the existing environmental map and the new environmental map, the data of the environmental map with higher reliability (in other words, smaller variance of an estimated value distribution) is prioritized.

In the embodiment, the environmental map that has been generated by the map generation unit 111 and that has not been used for update processing performed by the map update unit 113 is referred to as a new map. In addition, the environmental map stored in the memory unit 12 is referred to as an existing map. The update processing refers to obtaining a new environmental map (referred to as an updated map) by fusing the new map and the existing map. Further, when the updated map is stored in the memory unit 12, the stored updated map is referred to as an existing map.

FIG. 3B is a schematic diagram illustrating a relationship among the existing map, the new map, and the updated map for a position of a feature on a map. A solid curve line, a fine broken curve line, and a coarse broken curve line indicate the distributions of the estimated values of the positions of features on the updated map, the existing map, and the new map, respectively. An X bar corresponds to the average value (in other words, the estimated position of the feature) of the position coordinates of the feature on the updated map. An X₁ bar corresponds to the average value (in other words, the estimated position of the feature) of the position coordinates of the feature on the existing map. An X₂ bar corresponds to the average value (in other words, the estimated position of the feature) of the position coordinates of the feature on the new map.

The map update unit 113 fuses the data of the existing map and the data of the new map using the following expressions (1) to (3) at the time of update to obtain the data of the updated map.

$$\\ \begin{matrix}[ Expression 1 ] & \\ \overline{X} = \frac{{w}_{1} \overline{{X}_{1}} + {w}_{2} \overline{{X}_{2}}}{{w}_{1} + {w}_{2}} & ( 1 )\end{matrix}$$

Note that, a reference sign w₁ indicates a weight for the estimated position X₁ bar of the feature on the existing map, and a reference sign w₂ indicates a weight for the estimated position X₂ bar of the feature on the new map.

$$\\ \begin{matrix}[ Expression 2 ] & \\ {w}_{1} = \frac{{n}_{1}}{{σ}_{1}^{{}_{} 2}} & ( 2 )\end{matrix}$$

$$\\ \begin{matrix}[ Expression 3 ] & \\ {w}_{2} = \frac{{n}_{2}}{{σ}_{2}^{{}_{} 2}} & ( 3 )\end{matrix}$$

As shown in the expression (2), the map update unit 113 sets a reciprocal n₁/σ₁² of the variance of the normal distribution N of the existing map as a weight w₁ for the data of the existing map. In addition, as shown in the expression (3), the map update unit 113 sets a reciprocal n₂/σ₂² of the variance of the normal distribution N of the new map as a weight w₂ for the data of the new map.

Note that, reference signs n₁ and σ₁ indicate the number of samples and the standard deviation of the existing map, respectively, and reference signs n₂ and σ₂ indicate the number of samples and the standard deviation of the new map, respectively. As an example, in the embodiment, exemplified is a case where the number of samples of the new map n₂=5 is satisfied. Therefore, the value of the number of samples of the existing map n₁ increases by five every update. Note that, the value of the number of samples n₂ is not limited to five, and may be appropriately changed.

In the example of FIG. 3B, since the waveform width of the normal distribution N of the existing map is narrower than the waveform width of the normal distribution N of the new map, the variance σ₁²/n₁ of the normal distribution N of the existing map is smaller than the variance σ₂²/n₂ of the normal distribution N of the new map. Therefore, since the weight of the existing map w₁ is larger than the weight of the new map w₂, the updated map is more greatly affected by the existing map than the new map. Conversely, the influence of the new map on the updated map is smaller than the influence of the existing map.

Note that, in a case where any of the above generation sections of the new environmental map newly generated by the map generation unit 111 is not included in the existing environmental map stored in the memory unit 12, the map update unit 113 directly adds the data (the number of samples n₂=5) and the reliability of the above generation sections of the new environmental map to the existing environmental map to update the existing environmental map. In this case, since the weight of the existing map w₁ corresponds to 0 and the weight of the new map w₂ corresponds to 1, the data of the new map is newly added to the updated map. When the updated map is stored in the memory unit 12, the updated map becomes the existing map, and the value of the number of samples of the existing map n₁ in the newly added section is five until the data of the section is updated next.

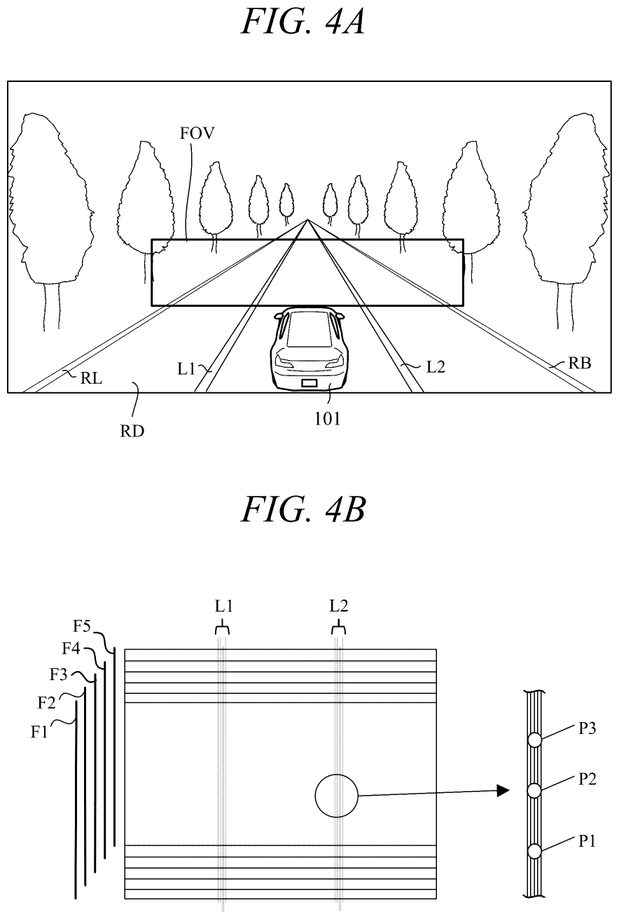

FIG. 4A is a diagram illustrating a scene where a subject vehicle 101 travels on a road RD. In the scene illustrated in FIG. 4A, the map generation unit 111 generates the environmental map recording the position information of the division lines L1, L2 and the like defining the travel lane on which the subject vehicle 101 travels, and the reliability calculation unit 112 calculates the reliability of the environmental map on the basis of the position information of the division lines L1, L2 and the like.

The exterior environment recognition unit 14 recognizes, as road boundary lines RL and RB, curbstones, walls, grooves, guardrails, or division lines indicating boundary lines of the road RD on the basis of the camera image acquired by the camera 1a, for example, to recognize a road structure indicated by the boundary lines RL and RB. As described above, the division lines L1, L2 and the like include a white line (including a line in a different color), a curbstone line, a road stud, or the like, and the travel lane of the road RD is defined by markings with these division lines L1, L2 and the like.

Note that, an example in which the exterior environment recognition unit 14 recognizes a region sandwiched between the boundary lines RL and RB as a region corresponding to the road RD has been disclosed, but the recognition method of the road RD is not limited thereto, and the recognition may be performed by other methods.

FIG. 4B is a schematic diagram illustrating the camera image acquired by the camera 1a on a two-dimensional map in which the road RD is viewed from above. The vertical direction of FIG. 4B corresponds to the depth direction as seen from the subject vehicle 101, and the horizontal direction of FIG. 4B corresponds to the road width direction as seen from the subject vehicle 101.

The subject vehicle position recognition unit 13 acquires the position information of a feature (feature point) from the environmental map stored in the memory unit 12, and estimates the position of the subject vehicle 101 from the moving speed and the moving direction (for example, an azimuth angle) of the subject vehicle 101. Every time the camera image is acquired by the camera 1a through the measurement during traveling, the map generation unit 111 obtains the relative position of the feature based on the acquired camera image by coordinate-transforming the position of the subject vehicle 101 as a center.

Here, the angle of view of the camera 1a is set such that a blank section of data does not occur in the traveling direction of the road RD between the camera image of the previous frame acquired in the previous imaging and the camera image of the next frame acquired in the current imaging, and is set such that features at the same position on the road RD are commonly included in at least a predetermined number of consecutive frames (for example, five frames corresponding to the above number of samples n₂).

As an example, the map generation unit 111 is configured to acquire the position information of a feature (for example, a division line) on the basis of the position information commonly included in five frames from a latest frame F1 to a frame F5. As a result, for example, the division line L1 and the division line L2 are observed as five division lines L1 and five division lines L2 due to a shift or the like in the angle of view of the camera 1a occurring between frames due to a swing or the like of the traveling subject vehicle 101. The exterior environment recognition unit 14 calculates an approximate curve based on the division line L1 and the division line L2 observed in each frame for five frames. As a result, five approximate curves (for five frames) corresponding to the division lines L1 and the division lines L2 are obtained. When the region surrounded by the circle in the division lines L2 in FIG. 4B is focused and enlarged, the region is as illustrated on the right side.

As illustrated in FIG. 4B, the division lines at the same position on the road RD are configured to be commonly included in five consecutive frames, so that five (the number of samples n=5) position coordinates are obtained for the division lines at the same position on the road RD in one travel. The map generation unit 111 sets the estimated position of the division line in a new map obtained in one travel as an average value of five position coordinates. That is, the number of samples of the new map n₂ in the embodiment is five. At this time, the number of samples of the updated map n is n₁+5 obtained by adding the number of samples n₂ to the number of samples of the existing map n₁.

Points P1, P2, P3, . . . indicated by white circles in FIG. 4B correspond to the calculated positions of the reliability by the reliability calculation unit 112. The points P1, P2, P3, . . . indicate average values of position coordinates corresponding to the respective calculated positions acquired in the respective frames from the frame F1 to the frame F5, that is, estimated positions of the division lines L2. The points P1, P2, P3, . . . also correspond to the calculated positions of the data obtained by fusing the existing map and the new map by the map update unit 113.

### <Description of Flowchart>

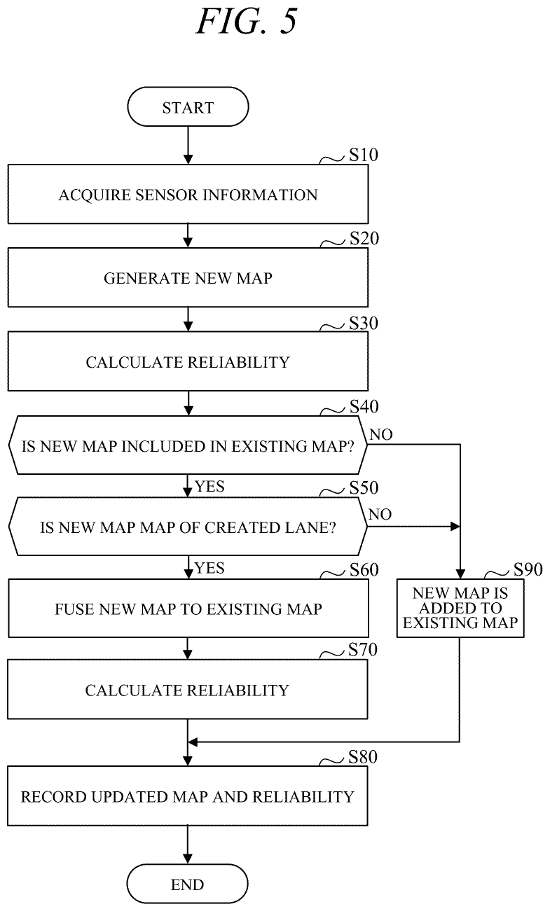

FIG. 5 is a flowchart illustrating an example of processing performed by the controller 10 in FIG. 2 according to a predetermined program. The processing illustrated in the flowchart is repeated at a predetermined cycle while a subject vehicle is traveling in the manual drive mode to generate an environmental map, for example.

In step S10 in FIG. 5, the controller 10 acquires sensor information from the camera 1a, the LiDAR 1b, and the sensor 2a, and the process proceeds to step S20.

In step S20, the controller 10 causes the map generation unit 111 to generate a new map, and the process proceeds to step S30.

In step S30, the controller 10 causes the reliability calculation unit 112 to calculate the reliability of the new map generated in step S20, and the process proceeds to step S40. The reliability calculation unit 112 performs calculation processing of the reliability for each piece of position information included in the new map. The reliability calculation unit 112 calculates the estimated value distribution (normal distribution) of the position information of the feature as the reliability of the new map.

In step S40, the controller 10 determines whether or not the new map is included in the existing map. In a case where at least a part of the creation section of the new map newly generated by the map generation unit 111 is included in the existing map stored in the memory unit 12, the controller 10 makes an affirmative determination in step S40, and the process proceeds to step S50. In a case where the creation section of the new map is not included in the existing map, the controller 10 makes a negative determination in step S40, and the process proceeds to step S90.

In step S50, the controller 10 determines whether or not the new map is a map of the lane that has been created in the existing map. In a case where the new map is a map of the travel lane that has been created, the controller 10 makes an affirmative determination in step S50, and the process proceeds to step S60. In a case where the new map is a map of a travel lane that has not been created, the controller 10 makes a negative determination in step S50, and the process proceeds to step S90.

In step S60, the controller 10 causes the map update unit 113 to fuse the new map to the existing map. Specifically, the map update unit 113 fuses the data of the corresponding section of the existing map corresponding to the generation section of the new map on the basis of the data and the reliability of the above generation section of the new map and the data and the reliability of the above corresponding section of the existing map stored in the memory unit 12. The fusion processing is based on the above expressions (1) to (3). The map update unit 113 performs the above fusion processing for each piece of position information included in the environmental map.

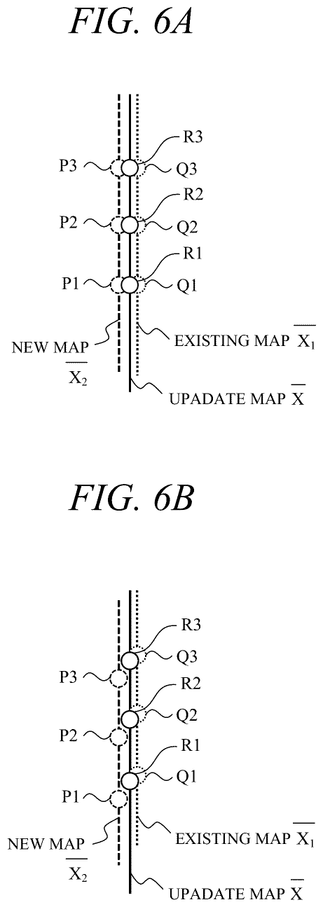

FIG. 6A is a schematic diagram illustrating the fusion processing on the section corresponding to the enlarged diagram illustrated on the right side in FIG. 4B. Points R1, R2, R3, . . . indicated by white circles in FIG. 6A correspond to the respective calculated positions of the reliability of the updated map by the reliability calculation unit 112. Each of the points R1, R2, and R3, . . . is a position coordinate of the division line L2 included in the data of the updated map, and more specifically, indicates an average value (X bar) of position coordinates corresponding to respective calculated positions acquired in a plurality of consecutive frames. In addition, points Q1, Q2, Q3, . . . indicated by white circles in fine broken lines in FIG. 6A respectively correspond to the calculated positions of the reliability of the existing map by the reliability calculation unit 112. Each of the points Q1, Q2, and Q3, . . . is a position coordinate of the division line L2 included in the data of the existing map, and more specifically, indicates an average value (X₁ bar) of position coordinates corresponding to respective calculated positions acquired in a plurality of consecutive frames. Further, the points P1, P2, P3, . . . indicated by white circles in coarse broken lines in FIG. 6A respectively correspond to the calculated positions of the reliability of the new map by the reliability calculation unit 112. Each of the points Q1, Q2, and Q3, . . . is a position coordinate of the division line L2 included in the data of the new map, and more specifically, indicates an average value (X₂ bar) of position coordinates corresponding to respective calculated positions acquired in a plurality of consecutive frames.

In the example of FIG. 6A, the updated map (X bar) is more greatly affected by the existing map (X₁ bar) than the new map (X₂ bar), and the estimated position of the division line L2 in the updated map (X bar) is closer to the estimated position of the division line L2 in the existing map (X₁ bar) than the estimated position of the division line L2 in the new map (X₂ bar).

The controller 10 performs the above fusion processing as update processing, and the process proceeds to step S70.

In step S70, the controller 10 causes the reliability calculation unit 112 to calculate the reliability of the updated map obtained by the fusion in step S60, and the process proceeds to step S80. The reliability calculation unit 112 performs calculation processing of the reliability for each piece of position information included in the updated map (existing map after update). The reliability calculation unit 112 calculates the estimated value distribution (normal distribution) of the position information of the feature as the reliability of the updated map.

In step S80, the controller 10 causes the map update unit 113 to record the updated map (environmental map) and the reliability information indicating the reliability of the updated map in the memory unit 12 as environmental map information, and the processing illustrated in FIG. 5 is ended.

Note that, in a case where the new map is added to the existing map in step S90 to be described later, the controller 10 additionally records the new map (environmental map) and the reliability information indicating the reliability of the new map in the memory unit 12 as environmental map information, and ends the processing illustrated in FIG. 5.

In step S90 to which the process proceeds when a negative determination is made in step S40 or step S50, the controller 10 causes the map update unit 113 to add the new map to the existing map. Specifically, the map update unit 113 directly adds the data and the reliability of the generation section of the new map to the existing environmental map information. The map update unit 113 performs addition processing of the new map for each piece of position information included in the new map. After the controller 10 performs the above addition processing, the process proceeds to step S80.

When calculating the reliability in the above steps S30 and S70, the reliability calculation unit 112 may set at least one of the position coordinate of the subject vehicle 101 on the environmental map, the number of samples n of the recognition information recognized by the exterior environment recognition unit 14, and the position information of the travel lanes (in other words, the division lines L1, L2 and the like that define the travel lanes) recognized by the exterior environment recognition unit 14 as a parameter, and calculate the estimated value distribution (normal distribution) of the position information on the basis of the parameter.

In addition, the reliability calculation unit 112 may also calculate the estimated value distribution having different variance values on the basis of at least one of the position information of the travel lanes acquired by the exterior environment recognition unit 14, the recognition result by the exterior environment recognition unit 14, the frequency of the update with respect to the above existing map, the presence or absence of a past travel history for the generation section of the above new map, and the travel frequency.

FIG. 6B is another schematic diagram illustrating fusion processing. In a case where the new map is fused to the existing map in the above step S60, as illustrated in FIG. 6B, the positions in the depth direction of the points P1, P2, P3, . . . indicating the average value (X₂ bar) of a plurality of predetermined position coordinates of the division lines L2 included in the data of the new map may not necessarily correspond to the positions in the depth direction of the points Q1, Q2, Q3, . . . indicating the average value (X₁ bar) of a plurality of predetermined position coordinates of the division lines L2 included in the data of the existing map.

In such a case, the map update unit 113 may calculate the predetermined position information of the points R1, R2, R3, . . . on the updated map on the basis of, for example, a map shape estimated from polynomial approximation using the data of the new map and the data of the existing map. Specifically, the map update unit 113 calculates the position information of the points R1, R2, R3, . . . on the updated map estimated using the method of weighted least squares using the following expression (4). Note that, in the following expression (4), a reference sign S indicates a cost function, a reference sign n indicates the number of data points, a reference sign m indicates a degree of the approximating polynomial, reference signs xᵢ and yᵢ indicate coordinate values for each of data points, a reference sign wᵢ indicates a weight for each of data points, and a reference sign θⱼ indicates a coefficient of the approximation polynomial.

$$\\ \begin{matrix}[ Expression 4 ] & \\ S = {\sum }_{i = 1}^{n} {{w}_{i} ( {y}_{i} - )}^{2} = {\sum }_{i = 1}^{n} {{w}_{i} ( {y}_{i} - {\sum }_{j = 0}^{m} {θ}_{j} {x}_{i}^{{}_{} j} )}^{2} & ( 4 )\end{matrix}$$

According to the embodiments described above, the following operations and effects are obtained.
(1) The map generation apparatus 50 includes: the exterior environment recognition unit 14 that recognizes an exterior environment situation around the subject vehicle 101 by using a detection data of the by using a detection data of an in-vehicle detector configured to detect an external situation around the subject vehicle 101; the map generation unit 111 that generates an environmental map including position information indicating a position of a predetermined feature on the basis of recognition information acquired by the exterior environment recognition unit 14; the reliability calculation unit 112 that calculates the reliability of the generated environmental map for each piece of position information; the memory unit 12 that stores the environmental map and the reliability information indicating the reliability as environmental map information; and the map update unit 113 that updates, when at least a part of the new map newly generated by the map generation unit 111 is included in the existing map stored in the memory unit 12 as environmental map information, the data of the corresponding section of the existing map corresponding to the generation section of the new map on the basis of the data and the reliability of the new map in the generation section and the data and the reliability of the existing map in the corresponding section.

With this configuration, in a case where the subject vehicle 101 travels on the same road RD, the existing map already created is updated using newly obtained recognition information every time the travel is repeated. At the time of update, the data of the corresponding section of the existing map corresponding to the generation section of the new map is updated on the basis of the data and the reliability of the new map in the generation section and the data and the reliability of the existing map in the corresponding section, so that it is possible not only to suppress a decrease in the accuracy of the map data due to the update, but also to increase the accuracy of the map data every time the existing map is updated by traveling on the road (in other words, the same road as the road traveled in the past) included in the existing map. This is because it is considered that, as the number of samples increases due to the central limit theorem, the average value (estimated value) approaches the true value.
(2) In the map generation apparatus 50 in (1) above, the reliability calculation unit 112 sets at least one of the position coordinate of the subject vehicle 101 in the map information, the number of samples n of the recognition information recognized by the exterior environment recognition unit 14, and the position information of the travel lanes recognized by the exterior environment recognition unit 14 as a parameter, and calculates the estimated value distribution of the position information of the feature as reliability information on the basis of the parameter.

With this configuration, probability distribution of population is estimated by the parameter based on the position information indicated on the map, so that the accuracy of the estimated value distribution as the reliability information is improved.
(3) In the map generation apparatus 50 in (2) above, the reliability calculation unit 112 calculates the estimated value distribution in the generation section when the new map is generated, and calculates the estimated value distribution in the corresponding section when the existing map is updated, and the map update unit 113 updates the position information of the existing map by fusing the existing map in the corresponding section and the new map in the generation section with the data of the map having smaller variance between the estimated value distribution calculated in the corresponding section of the existing map and the estimated value distribution calculated in the generation section of the new map prioritized.

With this configuration, at the time of updating the map, it is possible to preferentially fuse the map information having higher reliability between the existing map and the new map, and it is possible to suppress a decrease in the accuracy of the map data due to the update.
(4) In the map generation apparatus 50 in (3) above, the reliability calculation unit 112 sets a weight for the data of the existing map and the new map on the basis of at least one of the position information of the travel lanes recognized by the exterior environment recognition unit 14, the recognition result by the exterior environment recognition unit 14, the frequency of the update of the existing map, the presence or absence of a past travel history, and the travel frequency.

With this configuration, it is possible to appropriately update the map by setting the weight for determining the degree of priority between the existing map and the new map in fusion at the time of updating the map in consideration of the recognition information recognized by the exterior environment recognition unit 14, the frequency of updating the map, and the travel frequency.
(5) In the map generation apparatus 50 in (3) above, in a case where the positions in the depth direction of the points P1, P2, P3, . . . as the first position information of the feature in the generation section of the new map do not correspond to the positions in the depth direction of the points Q1, Q2, Q3, . . . as the second position information of the feature in the corresponding section of the existing map, the map update unit 113 updates the position information of the existing map by fusing the existing map of the corresponding section and the new map of the generation section on the basis of the map shape of the updated map estimated from polynomial approximation using the data of the new map in the generation section and the data of the existing map in the corresponding section.

With this configuration, in a case where a corresponding point to be fused between the new map and the existing map is not uniquely determined, the shape of the updated map is estimated from polynomial approximation, so that it is possible to update the map with less errors.
(6) In the map generation apparatus 50 in (1) above, the exterior environment recognition unit 14 recognizes an exterior environment situation at a predetermined frame rate, and the reliability calculation unit 112 calculates the reliability of the new map for each piece of position information of the same feature recognized in each of a plurality of frames with close acquisition times, and calculates the reliability of the existing map for each piece of position information of the same feature included in the existing map that has been updated by the map update unit 113.

With this configuration, even if the subject vehicle 101 does not travel on the same road RD a plurality of times, the reliability calculation unit 112 can calculate the reliability of the environmental map generated by the map generation unit 111 through only one travel for each piece of position information.

In addition, the reliability calculation unit 112 calculates the reliability for each piece of position information of the same feature included in the existing map that has been updated by the map update unit 113, so that the map update unit 113 can appropriately perform the next update based on the data and the reliability of the new map in the generation section and the data and the reliability of the existing map in the corresponding section.

The above embodiment can be modified into various forms. Hereinafter, modifications will be described.

### (First Modification)

In the embodiment, an example has been described in which, in a case where the subject vehicle 101 travels on the road RD and the map generation unit 111 newly generates a new map, the existing map is always updated in a case where there is a past travel history for the generation section, in other words, when the generation section of the new map is included in the existing map. Alternatively, for example, an opportunity to update the existing map may be restricted such that the map update unit 113 updates the existing map only when a driver intervenes in the driving operation of the subject vehicle 101 for the reason that the subject vehicle 101 in self-driving using the existing map information travels excessively to the edge of a travel lane or the like. More specifically, after making an affirmative determination in step S40, the controller 10 may cause the map update unit 113 to determine whether or not the driver has intervened in the driving operation in the generation section of the new map, and the process may be ended without proceeding to step S50 when the driver has not intervened in the driving operation. The presence or absence of the intervention in the driving operation may be determined on the basis of whether or not the operation of a steering wheel or the like has been detected on the basis of the sensor value of the internal sensor group 2, or may be determined using other methods.

With this configuration, it is possible to appropriately determine the update timing of the existing map such that the update is omitted for the existing map that does not interfere with the self-driving, while the update is performed for the existing map that is not suitable for the self-driving.

### (Second Modification)

In addition, in the embodiment, as a weight w used when the data of the existing map and the data of the new map are fused, the reciprocal of the variance (σ2/n) indicating the spread of the estimated value distribution (normal distribution) of the position information of the feature is set as the weight w (the smaller variance is, the larger the weight is, and the larger variance is, the smaller the weight is) for the estimated value distribution. Alternatively, the product w×w_{T} of the weight w for the estimated value distribution and a weight w_{T} (for example, the higher the update frequency of the existing map is, the larger the weight w_{T} is, or the newer the update date of the existing map is, the larger the w_{T} is) calculated from a temporal element may be adopted as the weight of the existing map wᵢ used when the data of the existing map and the data of the new map are fused. For example, in step S80, when the controller 10 causes the map update unit 113 to store the updated map and the reliability information of the updated map in the memory unit 12, the information (hereinafter, referred to as update history information) indicating an update time may be stored in the memory unit 12 in association with a section (hereinafter, referred to as an update section) corresponding to the updated map. When the update history information corresponding to the update section has already been stored in the memory unit 12, the update time of this time is added to the update history information. Thereafter, when the new map is fused to the existing map in step S60, the controller 10 acquires the update frequency and the newest update date of the map in the generation section of the new map from the update history information stored in the memory unit 12, and on the basis of the acquired information, calculates the above weight w_{T}.

With this configuration, it is possible to make the existing map that has just been updated less affected by the new map at the time of update. In other words, it is possible to make the old existing map where time has passed since the previous update easily affected by the new map at the time of update.

### (Third Modification)

In addition, in the embodiment, the exterior environment recognition unit 14 recognizes the exterior environment situation around the subject vehicle 101 using the camera images acquired by the camera 1a as an in-vehicle detector which detects the external situation around the subject vehicle 101. However, the exterior environment recognition unit may also recognize the external environment situation around the vehicle 101 using detection data of an in-vehicle detector other than the camera, such as radar or LiDAR.

The above embodiment can be combined as desired with one or more of the above modifications. The modifications can also be combined with one another.

According to the present invention, it is possible to increase the accuracy of map data every update.

Above, while the present invention has been described with reference to the preferred embodiments thereof, it will be understood, by those skilled in the art, that various changes and modifications may be made thereto without departing from the scope of the appended claims.

What is claimed is:

1. A map generation apparatus comprising:
an in-vehicle detector configured to detect an external situation around a subject vehicle; and
a microprocessor and a memory coupled to the microprocessor, wherein
the microprocessor is configured to perform:
recognizing an exterior environment situation around a subject vehicle by using a detection data of the in-vehicle detector;
generating a map including position information indicating a position of a predetermined feature based on recognition information acquired in the recognizing;
calculating a reliability of the map generated in the generating, for each piece of position information;
storing the map and reliability information indicating the reliability as map information; and
updating, when at least a part of a new map newly generated in the generating is included in the existing map stored in the memory unit as the map information, data of a corresponding section of the existing map corresponding to a generation section of the new map based on data and the reliability of the new map in the generation section and data and the reliability of the existing map in the corresponding section.

2. The map generation apparatus according to claim 1, wherein
the microprocessor is configured to perform
the calculating including setting at least one of a position coordinate of the subject vehicle in the map information, a number of samples of the recognition information acquired in the recognizing and the position information of travel lanes recognized in the recognizing as a parameter, and calculating an estimated value distribution of the position information of the feature as the reliability information based on the parameter.

3. The map generation apparatus according to claim 2, wherein
the microprocessor is configured to perform
the calculating including calculating the estimated value distribution in the generation section when the new map is generated, and calculating the estimated value distribution in the corresponding section when the existing map is updated, and
the updating including updating the position information of the existing map by fusing the existing map in the corresponding section and the new map in the generation section with the data of the map having smaller variance between the estimated value distribution calculated in the corresponding section of the existing map and the estimated value distribution calculated in the generation section of the new map prioritized.

4. The map generation apparatus according to claim 3, wherein
the microprocessor is configured to perform
the calculating including setting a weight for data of the existing map and the new map based on at least one of the position information of the travel lanes recognized in the recognizing, the recognition result in the recognizing, a frequency of update of the existing map, a presence or absence of a past travel history, and a travel frequency.

5. The map generation apparatus according to claim 3, wherein
the microprocessor is configured to perform
the updating including, in a case where first position information of the feature in the generation section of the new map do not correspond to second position information of the feature in the corresponding section of the existing map, updating the position information of the existing map by fusing the existing map of the corresponding section and the new map of the generation section based on a map shape estimated from a polynomial approximation using the data of the new map in the generation section and the data of the existing map in the corresponding section.

6. The map generation apparatus according to claim 1, wherein
the microprocessor is configured to perform
the recognizing including recognizing the exterior environment situation at a predetermined frame rate, and
the calculating including, when calculating the reliability of the new map, calculating the reliability of the new map for each piece of position information of the same feature recognized in each of a plurality of frames with close acquisition times, and when calculating the reliability of the existing map, calculating the reliability of the existing map for each piece of position information of the same feature included in the existing map which has been updated.

7. The map generation apparatus according to claim 1 further comprising
a sensor configured to detect presence or absence of an intervention in the driving operation, wherein
the microprocessor is configured to perform
the updating including, when at least a part of the new map is included in the existing map, determining whether there has been intervention in the driving operation in the generation section of the new map based on the detection data of the sensor, and when there has not been intervention in the driving operation, not updating the data of the corresponding section of the existing map corresponding to the generation section.

8. The map generation apparatus according to claim 1 further comprising
an actuator for traveling, wherein
generating a travel trajectory for the subject vehicle based on the recognized position of the subject vehicle and the external situation around the subject vehicle detected by the in-vehicle detector, and
controlling the actuator so that the subject vehicle travels automatically along the target path.
